(19) United States
(12) Patent Application Publication
(10) Pub. No.: US 2020/0236961 A1
(43) Pub. Date: Jul. 30, 2020

(54) TRAINING EQUIPMENT WITH COATING OF ORGANIC-FOOD POWDERS

(71) Applicant: Shuo-Hsiu Johnny CHANG, Taipei City (TW)

(72) Inventor: Shuo-Hsiu Johnny CHANG, Taipei City (TW)

(21) Appl. No.: 16/258,126

(22) Filed: Jan. 25, 2019

(51) Int. Cl. A23F 5/24; A61H 15/00; A63B 21/00; A63B 21/055; A23C 9/00; A23L 19/00

(52) U.S. Cl. CPC A23F 5/24; A61H 15/0092; A63B 21/00043; A61H 2015/0042; A23C 9/00; A23L 19/00; A63B 21/0552

(57) ABSTRACT

A training equipment with a coating of organic-food powders includes a main body and a mixture layer of organic-food powders. The main body has an outer surface. The mixture layer of organic-food powders is provided to coat the outer surface of the main body.

### BACKGROUND OF THE INVENTION

### 1. Field of the Invention

The invention relates to a training equipment, and more particularly to a training equipment with a coating of organic-food powders.

### 2. Description of the Prior Art

Recently, with prosperity of sports atmosphere, development of sports wearing, accessories and other supplies are booming. In 2014, it is a historic record that the yearly sale of the yoga pants exceeded that of jeans. Therefrom, it is obvious that sports have become an important part of daily life. Booming of gyms provides another evidence for the importance of the sports to the ordinary people nowadays.

No matter what the sports are fitness or yoga, the common features include fat burning and muscle enhancing. Thus, more and more people are purposely to integrate the fitness and yoga moves, and thereby associated supplies become hot.

For example, the yoga pad is well known to be an elastic pad for the yoga practitioners to exercise thereon. With the isolation provided by the yoga pad, possible harms from the hard floor can be effectively reduced, especially to injuries upon the knee. While in performing high-risk yoga moves, the use of yoga pads do provide a reliable protection against possible knee injuries.

In addition, tension plates and tension tubes are popular supplies for the versatile yoga sports. Besides, the tension plates and the tension tubes are both important accessories in resistance training for general fitness sports. In the sports, the training resistance may come from the user's weight or foreign loading. In a typical resistance training, sufficient sport strength would contribute to stimulate the body reactions and to enhance body functions, muscle endurance and muscle strength.

Nevertheless, though the aforesaid training equipment can promote the performance of high-risk moves, yet hikes in body temperature and sweating amount would be inevitable. General speaking, while the user applies the training equipment, at least a portion of user's body would contact with the training equipment.

However, for the conventional training equipment, it usually contains color powders, PVC (Polyvinyl chloride), plasticizers, stabilizers and the like chemicals. When the user contact the conventional training equipment for a longer time period, then it would be quite possible to induce allergic reaction upon user's skin. In addition, if the body temperature of the user is high during the usage of the training equipment, it would be possible that some allergic chemical substances would be discharged from the training equipment.

### SUMMARY OF THE INVENTION

In view that the conventional training equipment may cause allergic reaction to its user, accordingly, it is an object of the present invention to provide a training equipment with a coating of organic-food powders, that can reduce the possibility of user's allergic reaction.

In the present invention, the training equipment with a coating of organic-food powders includes a main body and a mixture layer of organic-food powders. The main body has an outer surface. The mixture layer of organic-food powders is furnished to coat the outer surface of the main body.

In one embodiment of the present invention, the mixture layer of organic-food powders is one of a mixture layer of bamboo-charcoal powders, a mixture layer of coffee powders, a mixture layer of cocoa powders, a mixture layer of milk powders, a mixture layer of matcha powders, a mixture layer of curcuma powders, a mixture layer of curry powders, a mixture layer of orange powders and a mixture layer of strawberry powders.

In one embodiment of the present invention, the main body is a massage ball.

In one embodiment of the present invention, the training equipment further includes a rope member, and the rope member penetrates through a through hole of the main body.

In one embodiment of the present invention, the outer surface of the main body further has a plurality of bump structures.

In one embodiment of the present invention, the main body is one of a yoga pad and a tension-plate structure.

In one embodiment of the present invention, the main body includes a tension tube. Preferably, the main body further includes a first grip member and a second grip member, connected opposing ends of the tension tube, respectively. In addition, the main body further includes a first coated member and a second coated member, sleeving the first grip member and the second grip member, respectively.

As stated above, the training equipment with a coating of organic-food powders provided by the present invention has an exterior mixture layer of organic-food powders to coat the outer surface of the main body of the training equipment, thus, in comparison with the prior art, the possibility of skin allergy to the user can be substantially reduced.

All these objects are achieved by the training equipment with a coating of organic-food powders described below.

### BRIEF DESCRIPTION OF THE DRAWINGS

The present invention will now be specified with reference to its preferred embodiment illustrated in the drawings, in which:

FIG. 1 is a schematic perspective view of a first embodiment of the training equipment with a coating of organic-food powders in accordance with the present invention;

FIG. 2 is a schematic cross-sectional view of FIG. 1 along line A-A;

FIG. 3 is a schematic perspective view of a second embodiment of the training equipment with a coating of organic-food powders in accordance with the present invention;

FIG. 4 is a schematic perspective view of a third embodiment of the training equipment with a coating of organic-food powders in accordance with the present invention;

FIG. 5 is a schematic perspective view of a fourth embodiment of the training equipment with a coating of organic-food powders in accordance with the present invention; and

FIG. 6 is a schematic perspective view of a fifth embodiment of the training equipment with a coating of organic-food powders in accordance with the present invention.

### DESCRIPTION OF THE PREFERRED EMBODIMENT

The invention disclosed herein is directed to a training equipment with a coating of organic-food powders. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

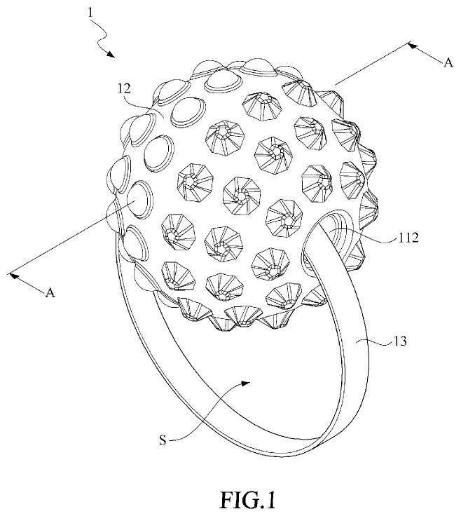

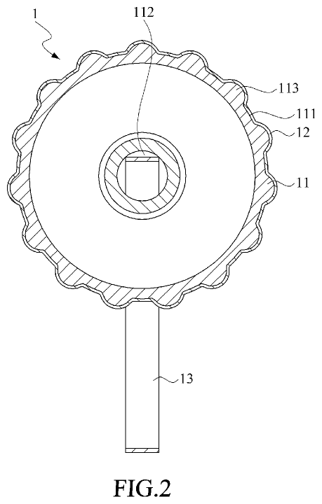

Referring now to FIG. 1 and FIG. 2; where FIG. 1 is a schematic perspective view of a first embodiment of the training equipment with a coating of organic-food powders in accordance with the present invention, and FIG. 2 is a schematic cross-sectional view of FIG. 1 along line A-A. As shown, the training equipment with a coating of organic-food powders 1 includes a main body 11 and a mixture layer of organic-food powders 12.

The main body 11 of the training equipment 1 has an outer surface 111. The mixture layer of organic-food powders 12 is furnished to coat the outer surface 111 of the main body 11, so that the main body 11 can be prevented from ill exterior environmental contacts.

The mixture layer of organic-food powders 12 can be one of a mixture layer of bamboo-charcoal powders, a mixture layer of coffee powders, a mixture layer of cocoa powders, a mixture layer of milk powders, a mixture layer of matcha powders, a mixture layer of curcuma powders, a mixture layer of curry powders, a mixture layer of orange powders, a mixture layer of strawberry powders and any mixture layer containing organic food powders.

In addition, in the present invention, the bamboo-charcoal powders, the coffee powders or the cocoa powders can be used to replace the conventional brown powders or black powders; the matcha powders can be used to replace the conventional green powders; the curcuma powders or the curry powders can be used to replace the conventional yellow powders; the milk powders can be used to replace the conventional white powders or the beige powders and mixture layer of strawberry powders can be used to replace the conventional orange powders or red powders.

In addition, the mixture layer of organic-food powders 12 can be a mixture layer of flammulina-velutipes powders, a mixture layer of snake-skin fruit powders, a mixture layer of white-bean powders, a mixture layer of lotus-leaf abstract powders, a mixture layer of butterfly-bean flower powders, a mixture layer of rose powders, a mixture layer of cucumber powders, a mixture layer of longan powders, a mixture layer of dew-grass powders, a mixture layer of apricot powders, a mixture layer of ginseng fruit powders, a mixture layer of sage powders, a mixture layer of mandarins powders, a mixture layer of astaxanthin powders, a mixture layer of sea-buckshot powders, a mixture layer of garlic abstract powders, a mixture layer of black rice powders, a mixture layer of black cherry powders, a mixture layer of black-eyebrow powders, a mixture layer of pineapple powders, a mixture layer of pecan powders, a mixture layer of bovine liver powders, a mixture layer of red dragon fruit powders, a mixture layer of honey powders, a mixture layer of sunkist orange powders, a mixture layer of parsley powders, a mixture layer of grapefruit powders, a mixture layer of raspberry powders, a mixture layer of burdock powders, a mixture layer of onion powders, a mixture layer of kiwi powders, a mixture layer of cabbage powders, a mixture layer of cantaloupe powders, a mixture layer of mountain-berry powders, a mixture layer of white melon powders, a mixture layer of grape powders, a mixture layer of carrot powders, a mixture layer of wild cherry-plum powders, a mixture layer of magnolia abstract powders, a mixture layer of white willow powders, a mixture layer of sand date powders, a mixture layer of hibiscus powders, a mixture layer of emblica powders, a mixture layer of chestnut powders, or any other mixture layer containing vegetable powders, fruit powders, bean powders or the like organic food powders.

In the mixture layer of organic-food powders 12, the ingredients generally include at least one plastics such as Polystyrene (PS), Polypropylene (PP), Polyvinyl Chloride (PVC), Acrylonitrile Butadiene Styrene (ABS), thermoplastic Elastomer (TPE), thermoplastic Rubber (TPR), SBS Rubber (Styrene-butadiene-styrene block copolymer), SEBS Rubber (Styrene-ethylene/butylene-styrene rubber) and the like thermoplastic plastics.

In this embodiment, the main body 11 can be a massage ball for promoting health. The training equipment 1 can further include a rope member 13. The main body 11 is further furnished with a through hole 112, and further has a plurality of bump structures 113. The rope member 13 is to penetrate through the through hole 112.

Thus, a user can have one of his/her finger to extend into an accommodation space S defined by the rope member 13, and then allows the training equipment 1 to roll on his/her body, such that the bump structures 113 can stimulate the body so as thereby to increase his/her muscle strength and, on the other hand, to relieve muscle pains.

In this invention, the mixture layer of organic-food powders 12 replaces the conventional color powders, parts of plastic materials, plasticizers, stabilizers and the like chemicals. Hence, while a user uses the training equipment 1, direct contacts between user's skin and the mixture layer of organic-food powders 12 of the training equipment 1 would be inevitable. Since the mixture layer of organic-food powders 12 includes powders of organic foods, which would cause less allergic reaction to the skin. Also, with the mixture layer of organic-food powders 12 to wrap completely the entire main body 11, the main body 11 can be protected from the surrounding environment. On the other hand, the possibility of the main body 11 discharging poison substances to the environment would be substantially reduced.

In addition, the mixture layer of organic-food powders 12 can also discharge natural aroma of the organic foods, and thus possible notorious odors left by previous users can be reduced. Further, if the training equipment 1 is discarded anyway, the mixture layer of organic-food powders 12 would be much easier to be decomposed. Thereupon, pollutions and damages to the environment would be further reduced.

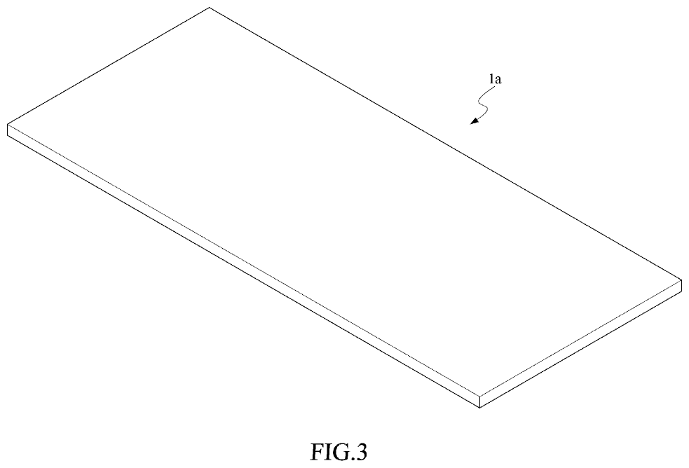

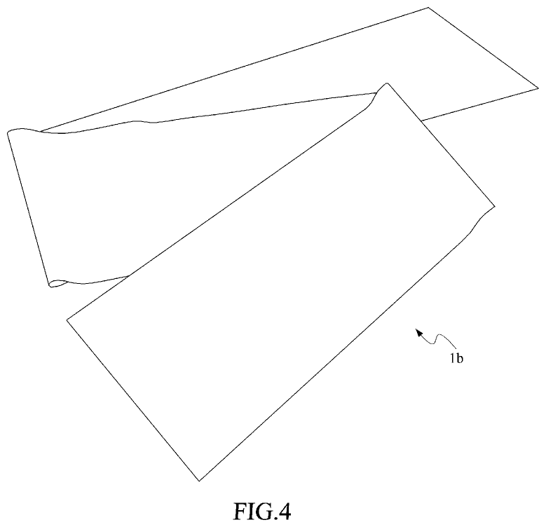

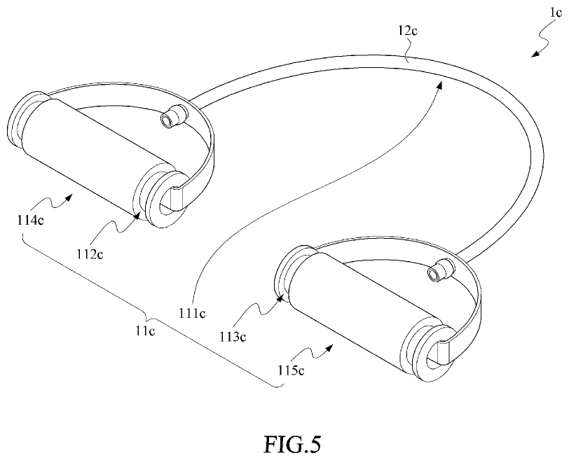

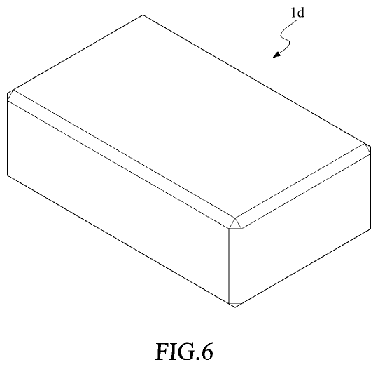

Then, refer to FIG. 3 through FIG. 6; where FIG. 3 is a schematic perspective view of a second embodiment of the training equipment with a coating of organic-food powders in accordance with the present invention, FIG. 4 is a schematic perspective view of a third embodiment of the training equipment with a coating of organic-food powders in accordance with the present invention, FIG. 5 is a schematic perspective view of a fourth embodiment of the training equipment with a coating of organic-food powders in accordance with the present invention, and FIG. 6 is a schematic perspective view of a fifth embodiment of the training equipment with a coating of organic-food powders in accordance with the present invention. In these drawings, various embodiments of the training equipment 1a, 1b, 1c and 1d are shown, respectively.

Each of the training equipments 1a, 1b, 1c, 1d, largely resembled to the training equipment 1, has a main body and a mixture layer of organic-food powders coating the main body to prevent the main body from contacting the environment directly.

The main body of the training equipment 1a is a yoga pad for the user to practice yoga or other fitness exercises thereon, so as not to get hurt by directly contacting the hard floor.

The main body of the training equipment 1b is a tension-plate structure for helping the user to practice various yoga and other resistance training.

In the fourth embodiment, the training equipment with a coating of organic-food powders 1c, configured as a tension tube, includes a main body 11c and a mixture layer of organic-food powders 12c. The main body 11c includes a tension tube 111c, a first grip member 112c, a second grip member 113c, a first coated member 114c and a second coated member 115c.

The first grip member 112c and the second grip member 113c are connected with two opposing ends of the tension tube 111c, respectively. The first coated member 114c sleeves the first grip member 112c, and the second coated member 115c sleeves the second grip member 113c.

Since the mixture layer of organic-food powders 12c is to coat the outer surface of the main body 11c, thus, in the figure, the tension tube 111c, the first grip member 112c, the second grip member 113c, the first coated member 114c and the second coated member 115c are only indicated by corresponding arrow lines. Namely, in this embodiment, the mixture layer of organic-food powders 12c is furnished to coat the tension tube 111c, the first grip member 112c, the second grip member 113c, the first coated member 114c and the second coated member 115c. Hence, while a user hand holds the training equipment with a coating of organic-food powders 1c, his/her hand would contact directly the mixture layer of organic-food powders 12c, not the main body 11c, and thus the possibility of allergic reaction would be substantially reduced.

In addition, in some other embodiments of the present invention not shown here, the user may solely use the tension tube 111c of the main body 11c of the training equipment with a coating of organic-food powders 1c for fitness.

In the fifth embodiment of the present invention, the training equipment with a coating of organic-food powders 1d includes a main body formed as a yoga brick. The training equipment with a coating of organic-food powders 1d is used to help the user to practice various yoga moves, and thus the main body would frequently contact his/her hands, legs, feet, neck, back, hip and the other part of the body. With the main body to be coated by the mixture layer of organic-food powders, then the contact between the naked main body and user's skin would be reduced or completely prohibited. Thereupon, the main body would be prevented from direct contact with the surroundings, and thus possible allergic reaction upon the human body caused by the naked main body would be reduced to some degree.

In the aforesaid training equipments with a coating of organic-food powders 1a, 1b and 1d, since part of main body are irregular shaped, thus two steps of foaming can be introduced to produce the main body and the mixture layer of organic-food powders, if and only if the material of the secondary foaming is not affected by the material for the first foaming

In summary, since the training equipment with a coating of organic-food powders provided bun the present invention includes a mixture layer of organic-food powders, thus, in comparison with the prior art, the mixture layer of organic-food powders is introduced to contact user's skin, and therefore the possibility of allergic reaction caused by direct skin contact with the baked main body can be substantially reduced. In addition, since the mixture layer of organic-food powders wraps completely the main body of the training equipment to inhibit direct contact between the naked main body of the training equipment and the surrounding atmosphere, thus the possibility of the main body discharging poison substances to the environment would be substantially reduced.

While the present invention has been particularly shown and described with reference to a preferred embodiment, it will be understood by those skilled in the art that various changes in form and detail may be without departing from the spirit and scope of the present invention.

What is claimed is:

1. A training equipment with a coating of organic-food powders, comprising:
a main body, having an outer surface; and
a mixture layer of organic-food powders, coating the outer surface.

2. The training equipment with a coating of organic-food powders of claim 1, wherein the mixture layer of organic-food powders is one of a mixture layer of bamboo-charcoal powders, a mixture layer of coffee powders, a mixture layer of cocoa powders, a mixture layer of milk powders, a mixture layer of matcha powders, a mixture layer of curcuma powders, a mixture layer of curry powders, a mixture layer of orange powders and a mixture layer of strawberry powders.

3. The training equipment with a coating of organic-food powders of claim 1, wherein the main body is a massage ball.

4. The training equipment with a coating of organic-food powders of claim 3, further including a rope member finished to penetrate through a through hole of the main body.

5. The training equipment with a coating of organic-food powders of claim 3, wherein the outer surface of the main body further has a plurality of bump structures.

6. The training equipment with a coating of organic-food powders of claim 1, wherein the main body is one of a yoga pad and a tension-plate structure.

7. The training equipment with a coating of organic-food powders of claim 1, wherein the main body includes a tension tube.

8. The training equipment with a coating of organic-food powders of claim 7, wherein the main body further includes a first grip member and a second grip member, connected with opposing ends of the tension tube, respectively.

9. The training equipment with a coating of organic-food powders of claim 8, wherein the main body further includes a first coated member and a second coated member, sleeving the first grip member and the second grip member, respectively.
